(19) United States
(12) Patent Application Publication
(10) Pub. No.: US 2004/0075287 A1
(43) Pub. Date: Apr. 22, 2004

(54) Hook device

(76) Inventor: Vincent Chang, Taichung (TW)

Correspondence Address: Vincent Chang, 58, MA YUAN WEST ST., TAICHUNG, TW

(21) Appl. No.: 10/273,760

(22) Filed: Oct. 16, 2002

(51) Int. Cl. B66C 1/34

(52) U.S. Cl. 294/82.17

(57) ABSTRACT

A hook device has a U-shaped main body, a locking pin, a rubber gasket, and a metal gasket. The U-shaped main body has a first end having a threaded hole and a second end having a round through hole and an inner annular taper portion. The locking pin has a threaded end, a blocking flange, an annular taper neck, and a holding head having a circular hole. The rubber gasket has a taper portion. The metal gasket has a taper portion. The metal gasket is inserted in the rubber gasket. The metal gasket surrounds the locking pin. The locking pin is inserted through the round through hole and the threaded hole of the U-shaped main body until the threaded end of the locking pin engages with the threaded hole of the U-shaped main body.

### BACKGROUND OF THE INVENTION

The present invention relates to a hook device. More particularly, the present invention relates to a hook device which is safer than a conventional hook device.

Referring to FIG. 1, a conventional hook device has a U-shaped main body 1′ and a locking pin 20′. The U-shaped main body 1′ has a first end 10′ having a threaded hole 13′ and a second end 11′ having a round through hole 12′. The locking pin 20′ has a threaded end 21′, a blocking flange 22′, and a holding head 24′ having a circular hole 25′. The locking pin 20′ is inserted through the round through hole 12′ and the threaded hole 13′ of the U-shaped main body 1′.

### SUMMARY OF THE INVENTION

An object of the present invention is to provide a hook device which has a rubber gasket and a metal gasket to facilitate a locking pin engaging with a main body stably.

In accordance with a preferred embodiment of the present invention, a hook device comprises a U-shaped main body, a locking pin, a rubber gasket, and a metal gasket. The U-shaped main body has a first end having a threaded hole and a second end having a round through hole and an inner annular taper portion. The locking pin has a threaded end, a blocking flange, an annular taper neck, and a holding head having a circular hole. The rubber gasket has a taper portion. The metal gasket has a taper portion. The metal gasket is inserted in the rubber gasket. The rubber gasket is inserted in the inner annular taper portion of the second end of the U-shaped main body. The metal gasket surrounds the locking pin. The locking pin is inserted through the round through hole and the threaded hole of the U-shaped main body until the threaded end of the locking pin engages with the threaded hole of the U-shaped main body.

In accordance with another preferred embodiment of the present invention, a hook device comprises a U-shaped main body, a locking pin, a rubber gasket, and a metal gasket. The U-shaped main body has a first end having a threaded hole and a second end having a round through hole and an inner annular taper portion. The locking pin has a threaded end, a blocking flange, an annular taper neck, and a holding head having a circular hole. The rubber gasket has a taper portion. The metal gasket has a taper portion and a plurality of periphery protrusions. The metal gasket is inserted in the rubber gasket. The rubber gasket is inserted in the inner annular taper portion of the second end of the U-shaped main body. The metal gasket surrounds the locking pin. The locking pin is inserted through the round through hole and the threaded hole of the U-shaped main body until the threaded end of the locking pin engages with the threaded hole of the U-shaped main body.

### BRIEF DESCRIPTION OF THE DRAWINGS

FIG. 1 is a perspective exploded view of a conventional hook device of the prior art;

FIG. 2 is a perspective exploded view of a hook device of a first preferred embodiment in accordance with the present invention;

FIG. 2 is a perspective view of a locking pin of a first preferred embodiment in accordance with the present invention;

FIG. 3 is a perspective assembly view of a hook device of a first preferred embodiment in accordance with the present invention;

FIG. 4 is a sectional assembly view of a hook device of a first preferred embodiment in accordance with the present invention;

FIG. 5 is a perspective assembly view of a hook device of a second preferred embodiment in accordance with the present invention; and

FIG. 6 is a perspective assembly view of a hook device of a third preferred embodiment in accordance with the present invention.

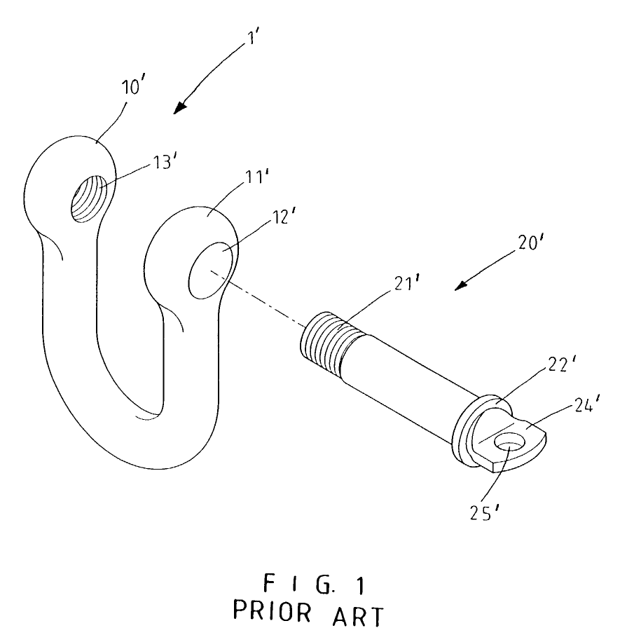

### DETAILED DESCRIPTION OF THE INVENTION

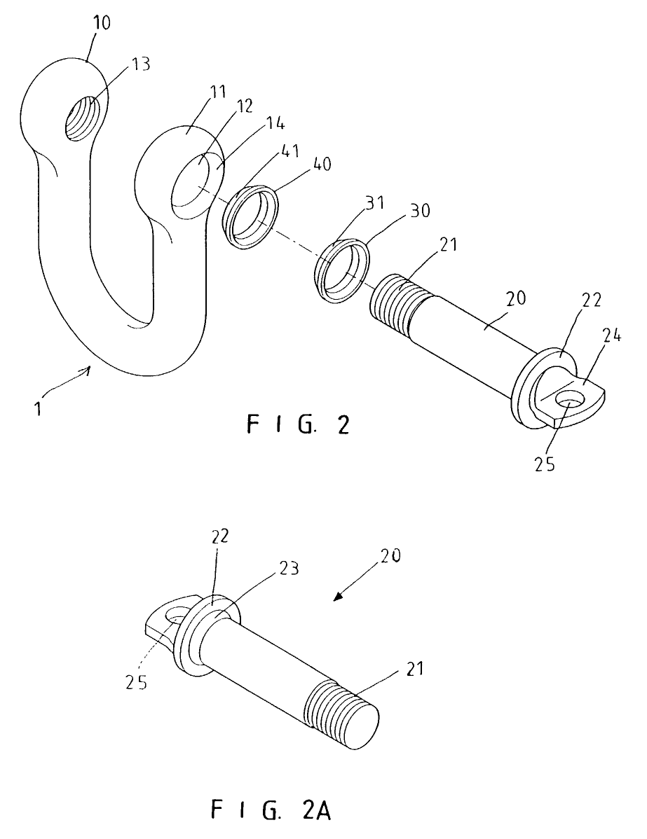

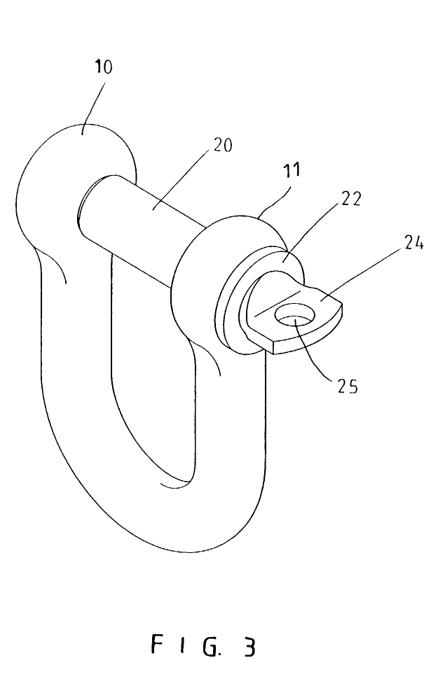

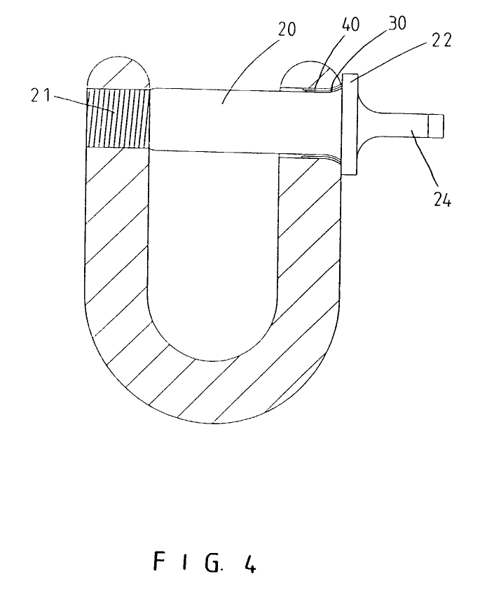

Referring to FIGS. 2 to 4, a first hook device comprises a U-shaped main body 1, a locking pin 20, a rubber gasket 40, and a metal gasket 30.

The U-shaped main body 1 has a first end 10 having a threaded hole 13 and a second end 11 having a round through hole 12 and an inner annular taper portion 14.

The locking pin 20 has a threaded end 21, a blocking flange 22, an annular taper neck 23, and a holding head 24 having a circular hole 25.

The rubber gasket 40 has a taper portion 41.

The metal gasket 30 has a taper portion 31.

The metal gasket 30 is inserted in the rubber gasket 40.

The rubber gasket 40 is inserted in the inner annular taper portion 14 of the second end 11 of the U-shaped main body 1.

The metal gasket 30 surrounds the locking pin 20.

The locking pin 20 is inserted through the round through hole 12 and the threaded hole 13 of the U-shaped main body 1 until the threaded end 21 of the locking pin 20 engages with the threaded hole 13 of the U-shaped main body 1.

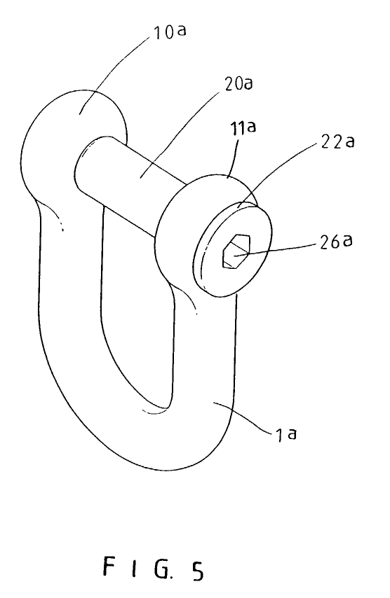

Referring to FIG. 5, a second hook device comprises a U-shaped main body 1a, a locking pin 20a, a rubber gasket (not shown in the figure), and a metal gasket (not shown in the figure).

The U-shaped main body 1a has a first end 10a and a second end 11a.

The locking pin 20a has a holding head 22a having a hexagonal hole 26a.

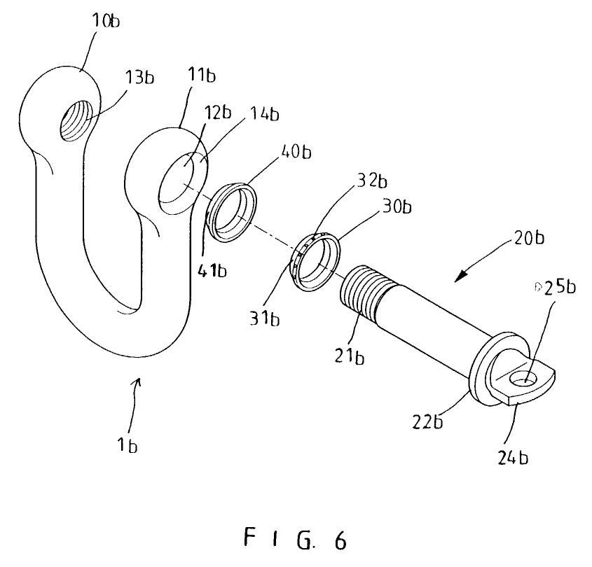

Referring to FIG. 6, a third hook device comprises a U-shaped main body 1b, a locking pin 20b, a rubber gasket 40b, and a metal gasket 30b.

The U-shaped main body 1b has a first end 10b having a threaded hole 13b and a second end 11b having a round through hole 12b and an inner annular taper portion 14b.

The locking pin 20b has a threaded end 21b, a blocking flange 22b, an annular taper neck 23b, and a holding head 24b having a circular hole 25b.

The rubber gasket 40b has a taper portion 41b.

The metal gasket 30b has a taper portion 31b and a plurality of periphery protrusions 32b.

The metal gasket 30b is inserted in the rubber gasket 40b.

The rubber gasket 40b is inserted in the inner annular taper portion 14b of the second end 11b of the U-shaped main body 1b.

The metal gasket 30b surrounds the locking pin 20b.

The locking pin 20b is inserted through the round through hole 12b and the threaded hole 13b of the U-shaped main body 1b until the threaded end 21b of the locking pin 20b engages with the threaded hole 13b of the U-shaped main body 1b.

The present invention is not limited to the above embodiments but various modification thereof may be made. Furthermore, various changes in form and detail may be made without departing from the scope of the present invention.

I claim:

1. A hook device comprises:
a U-shaped main body, a locking pin, a rubber gasket, and a metal gasket,
the U-shaped main body having a first end having a threaded hole and a second end having a round through hole and an inner annular taper portion,
the locking pin having a threaded end, a blocking flange, an annular taper neck, and a holding head,
the rubber gasket has a taper portion.
the metal gasket has a taper portion.
the metal gasket is inserted in the rubber gasket.
the rubber gasket is inserted in the inner annular taper portion of the second end of the U-shaped main body.
the metal gasket surrounds the locking pin.
the locking pin is inserted through the round through hole and the threaded hole of the U-shaped main body until the threaded end of the locking pin engages with the threaded hole of the U-shaped main body.

2. The hook device as claimed in claim 1, wherein the holding head has a hexagonal hole.

3. The hook device as claimed in claim 1, wherein the metal gasket has a plurality of periphery protrusions.
